(19) United States
(12) Patent Application Publication
(10) Pub. No.: US 2005/0188663 A1
(43) Pub. Date: Sep. 1, 2005

(54) Smoker

(76) Inventors: Jorge Bernardo Cuevas Peguero, Jamaica, NY (US); Kenia Ercira Rumaldo Soriano, Santo Domingo (DO)

Correspondence Address: Jorge B. Cuevas P., 108-36 160 st. apt 1c, Jamaica, NY, 11433, US

(21) Appl. No.: 11/042,873

(22) Filed: Jan. 24, 2005

Related U.S. Application Data
(60) Provisional application No. 60/539,737, filed on Jan. 29, 2004.

(51) Int. Cl. B01D 50/00

(52) U.S. Cl. 55/385.8

(57) ABSTRACT

A personal air cleaning apparatus for preventing secondhand tobacco smoke from reaching an ambient environment thereabout, which draws in, in a concentrated fashion, the blown smoke from a people, and outwardly discharges the air to a clean zone after the air has been filtered. The apparatus includes a funnel to put a cigar or cigarette to place it in the front of a smoker's nose and mouth and blow the inhaled smoke of a cigar or cigarette. the apparatus includes a sucking/discharging unit having a suction port for sucking in contaminated air, and a discharge port for discharging filtered air. a flexible conduit for connecting the sucking/discharging unit to the funnel.

### FIELD OF THE INVENTION

This invention is related to a new vacuum smoker system for use in motor vehicles such as a car, a boat, an airplane, etc. and in closed places in where the smoke scattering caused by tabacco is not desired, such as a house, an office, etc.

### BACKGROUND OF THE INVENTION

The invention relates more specifically to a vacuum smoking system which is operated from a vehicle battery (when it is installed in a vehicle) or with a power supply (when it is installed in a closed place such a house). The unit can if desired be used while the vehicle is in motion.

The present invention provides a flexible conduit with a head like a funnel, cut in a part, so that which uses the present invention can place it in the front of his (her) nose and mouth and blow the inhaled smoke of tabacco. The cigarette or cigar that is placed in a supporter that has a base and subjects within an opening by which the smoke of the tabacco and the ashes that cause are inhaled toward a central assembly that retains ashes and filters the smoke and lead it outside vehicle or of the closed place.

Thus the present invention provides in one aspect a central vacuum smoking assembly which is adapted for use in a vehicle such as an automobile, a boat, an airplane, etc. and in a closed place like a house, an office, etc.

The assembly comprises a flexible conduit, a waste collection chamber and an air withdrawal chamber which are detachably held together in a suitable manner.

The flexible conduit includes a cut funnel, with a cigarette or cigar supporter and a hose that transports the smoke and other matters towards The waste collection chamber.

The waste collection chamber includes an intake opening and two outlet opening, and said intake opening is adapted to cooperate with a conventional vacuum smoker line.

An opening exit located at the end of waste collection chamber and that has a door that is opened single when motor is turning on in opposite pole and fan is rotated directing air, particles and debris out of the waste collection chamber, like another option to clean the waste collection chamber; and the air outlet opening leading from the waste collection chamber to the air withdrawal chamber includes a waste retaining means comprising a partition which is adapted to retain particulate and liquid waste by gravity in the waste retaining section of the collection chamber. The outlet cooperates with an air filter for removal of fines from the air stream and thus the partition and air filter permit free exit of filtered air from the waste collection chamber and entry of said filtered air into the air withdrawal chamber.

There is an electric motor and associated fan impeller means in the air withdrawal chamber to draw filtered air into the air withdrawal chamber, and to expel the air through an outlet to the atmosphere, normally the hood of a car or other vehicle place or the closed place outside.

The assembly is designed to be easily and releasably installed, and readily removed, from the vehicle space, and the waste collection chamber and air withdrawal chamber are designed so as to be easily taken apart so that the waste collection chamber may be emptied, and the filter conveniently cleaned, when necessary.

### SUMMARY OF THE INVENTION

The general purpose of the present invention, which will be described subsequently in greater detail, is to provide a vacuum of the smoke of the tabacco that we smoke in close places, mainly in motor vehicles and which they are a danger for the health of the people which does not smoke, mainly is a great danger for the children, that are in the closed place with a person smoking.

In order to obtain this, the present invention uses a flexible secondary conduit with a head like a funnel, cut in a part so that which uses the present invention can place it in the front of his (her) nose and mouth and blow the inhaled smoke of the cigarette/cigar before placed in a cigarette/cigar supporter of the funnel.

It is, therefore, an object of the present invention to provide protection means for the people who does not smoke that they are in an closed place with one or several people smoking.

It is another object of the present invention to provide a vacuum smoker system that is effective in the prevention of the scattering of the tabacco smoke.

Another object of the present invention is to provide a vacuum smoker system that the person who smokes can smoke in a motor vehicle such as a car, a boat, an airplane, etc. without affects the people who are around.

Still another object of the present invention is to provide a vacuum smoking system that the person who smokes does not have to leave his (her) office, house, vehicle, etc. so that the tabacco smoke does not harm to the children or people who are in the same place.

Still another object of the present invention is to provide a vacuum smoking system which may be economically and easily manufactured.

Another object of the present invention is to provide a vacuum smoking system with a flexible conduit that it is possible to be stored easily.

Another object of the present invention is to provide a vacuum smoking system that the funnel can be separate so that the hose can be used like vacuum cleaner to clean some debris.

It is a further purpose of the present invention to provide new and improved vacuum smoking system for use in motor vehicles and closed places that are easy to install.

These, together with other objects and advantages which will become subsequently apparent, reside in the details of construction and operation as more fully described, reference being had to the accompanying drawings forming a part hereof, wherein like numerals refer to like parts throughout.

### BRIEF DESCRIPTION OF THE DRAWINGS

FIG. 1 is a perspective view, the head of the vacuum smoking like a cut funnel and the cigarette/cigar supporter assembled, show in FIG. 4.

FIG. 2 is, a perspective view of, the head of the vacuum smoking, showing the area of the a transparent plastic.

FIG. 3 shows a cross section in FIG. 2.

FIG. 4 is opinion of the cigarette/cigar supporter.

FIGS. 5, 6, 7, 9, 10, 11, 12 and 13 show various parts of a typical hose assembly.

FIG. 8 shows a typical vehicle interior surface port.

FIG. 14 shows as the connector of FIG. 7 is introduced through the port of FIG. 8 and opens the door of the port of FIG. 8.

FIG. 15 shows a typical quick connect arrangement of vacuum hoses for use of the smoking assembly in a typical motor vehicle situation.

FIG. 16 shows the present invention the way to use to blow the inhaled smoke.

FIG. 17 shows the central waste collection and air withdrawal assembly.

FIG. 18 is left-hand perspective view of the FIG. 17.

FIG. 19 is a sectional view of the embodiment of FIG. 17.

FIG. 20 shows semi-schematically a typically electrical wiring for this embodiment of this invention simple, that it shows switch mainly.

FIG. 21 is a opinion of the top part of FIG. 17.

FIG. 22 shows a right-hand view of FIG. 17.

FIG. 23 is a sectional view of FIG. 22.

FIG. 24 is a opinion of a top.

### DETAILED DESCRIPTION OF PREFERRED EMBODIMENT

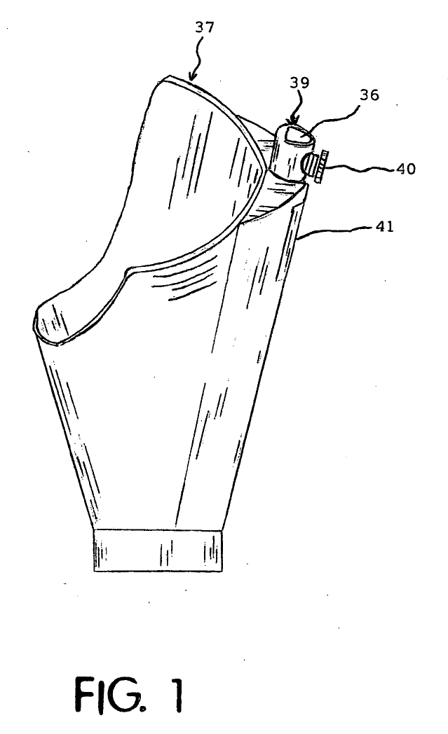

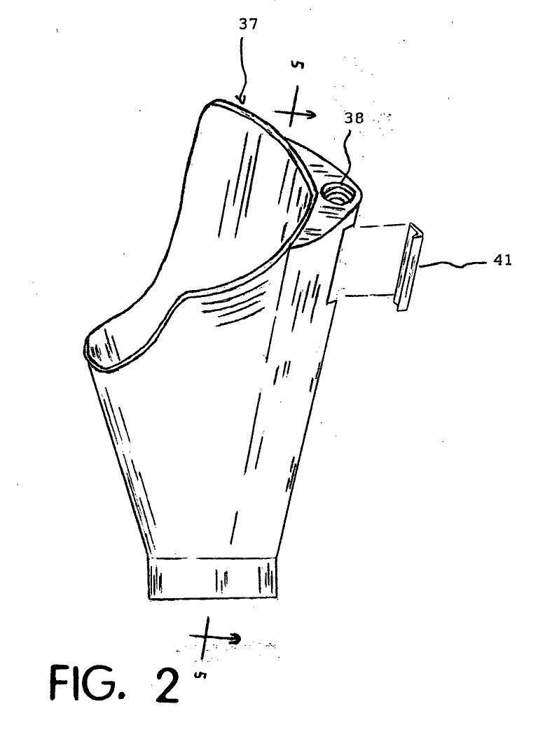

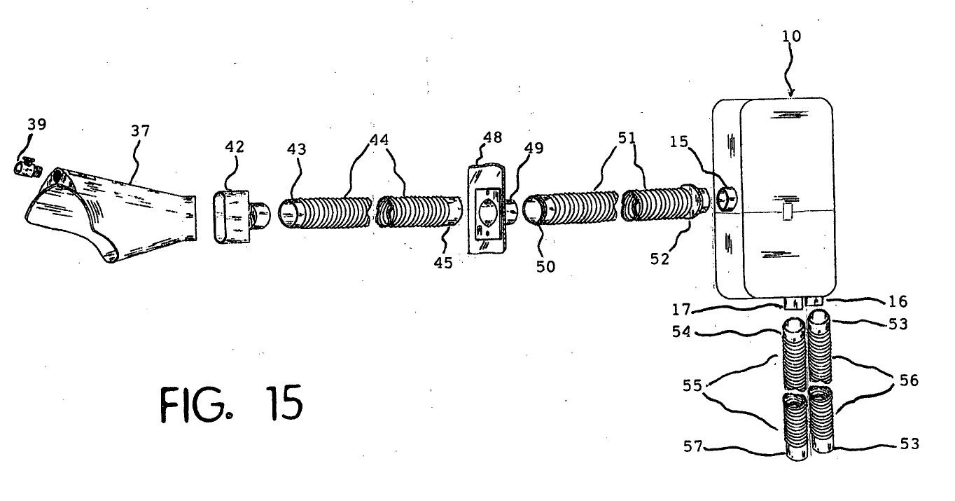

Referring now to FIG. 1, this is a opinion of head 37 of the assembly to smoke shown in FIG. 15, like a cut funnel, with a supporter 39 of the cigarette/cigar 67, which has an opening 36 with a metal tube inside (not shown) to introduce a cigarette or cigar 67 and to support it with a screw 40, and one screw threads 66 to screw the supporter 39 in the cigarette/cigar compartment 38 of the funnel 37.

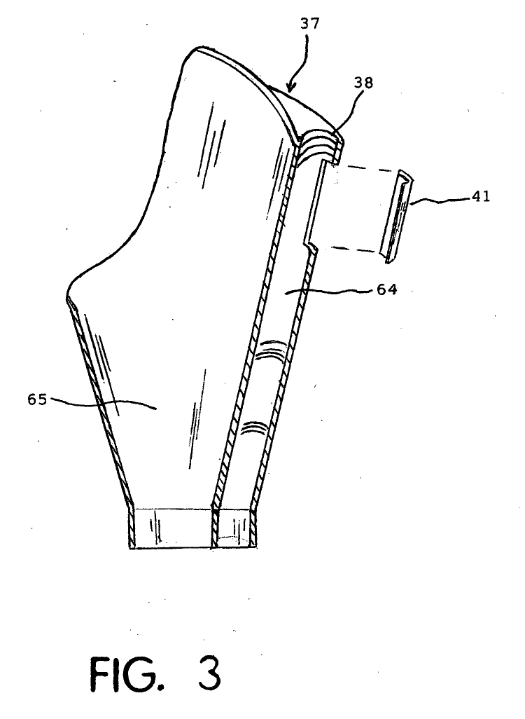

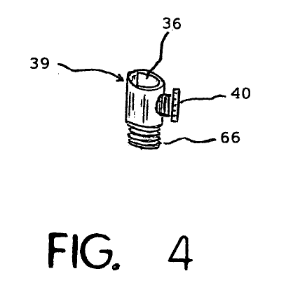

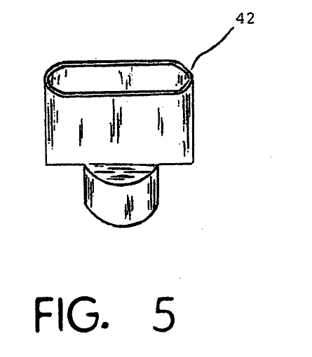

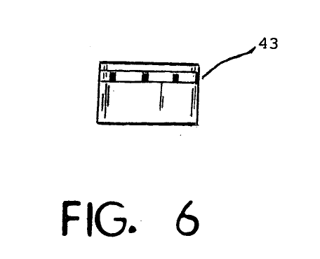

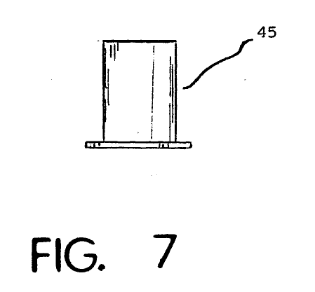

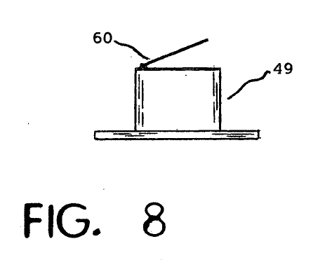

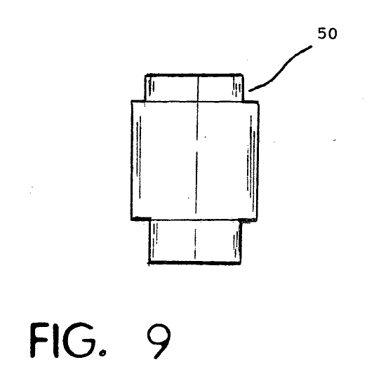

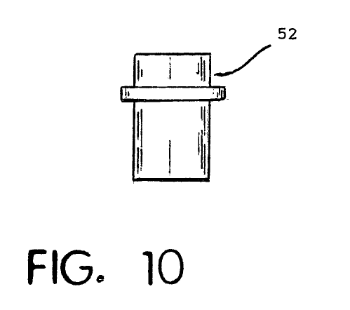

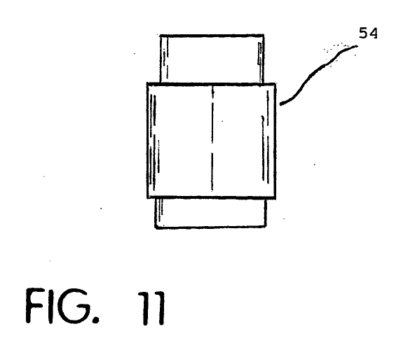

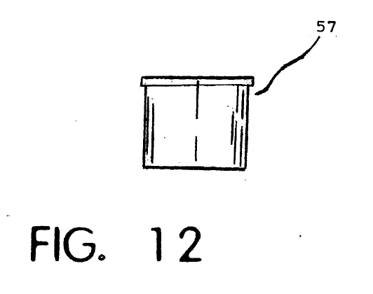

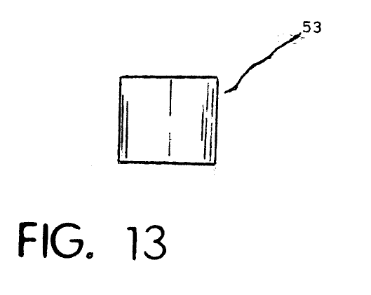

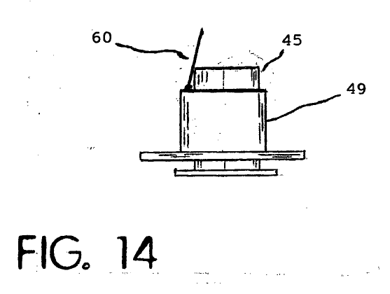

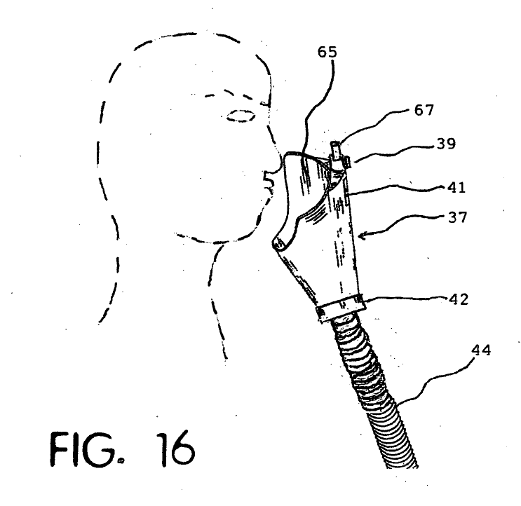

Head 37 has a conduit 64 capacity for a cigarette or cigar 67 and by which it suctions the smoke and ashes of the tabacco 67 through the arrangement of vacuum hoses (shown in FIG. 15) until the vacuum 10. An entrance 65 (shown in FIG. 3) by which suctions the smoke that we blow from mouth and nose when we are smoking (shown in FIG. 16) through the arrangement of vacuum hoses (shown in FIG. 15) until the vacuum 10. Besides funnel 37 has a transparency plastic 41 (shown in FIG. 1) that shows cigarette 67 consumption. FIG. 5 shows a connector 42, it connects in funnel 37 and unplug properly to use, besides, the present invention like vacuum cleaning system. FIG. 14 shows a connector 45 in a port 49, when introducing connector 45 opens a door 60 of the port 49 to allow the pass of smoke and debris.

FIG. 15 shows an embodiment of a hose assembly suitable for use in connection with this invention. Ready to be plugged into the inlet port 15 is a snap-in hose connector 52 joining hose 51 and leading to another connector 50 leading to a wall or a bulkhead 48 separating the car truck from the vehicle interior. Remote port 49 installed in partition 48 is accessible from the interior of the vehicle by hose 44 provided with a snap-in connector 45 at its proximal end and at its distal end with a further hose connector 43 adapted for deployment of a vacuum smoker nozzle 42 and a funnel 37. From a connector 45 till the funnel 37 this arrangement it can be separate to be stored easily. The arrangement may be such that plugging the vacuum hose into the outlet can activate the smoker automatically.

The various hoses or those connectors and nozzles are known in the art and may be chosen among parts readily available, for convenience and adaptability to the use set out for this invention.

Any standard corrugated or ribbed vacuum hose may be used for the connection to the automobile bulk-head and for the vacuum smoking portion inside the vehicle interior or a closed place. A fully collapsible or compressible ring type hose will save on storage space.

Talking about to FIG. 16 it demonstrates the way that is used the present invention for its better operation. After a person inhales tabacco smoke from a cigarette or cigar placed in supporter 39 and introduced cigarette or cigar 67 in the cigarette/cigar compartment 38, demonstrates the way to place funnel 37 in front of the face of a person who is smoking to blow by mouth and nose the inhaled smoke of the tabacco so does not scattering the smoke in the area.

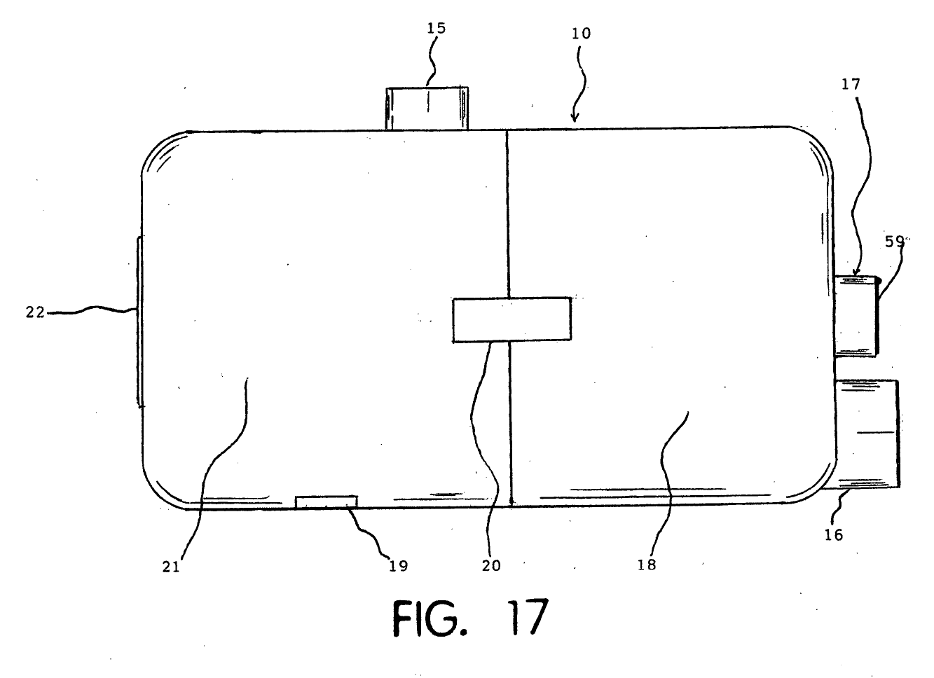

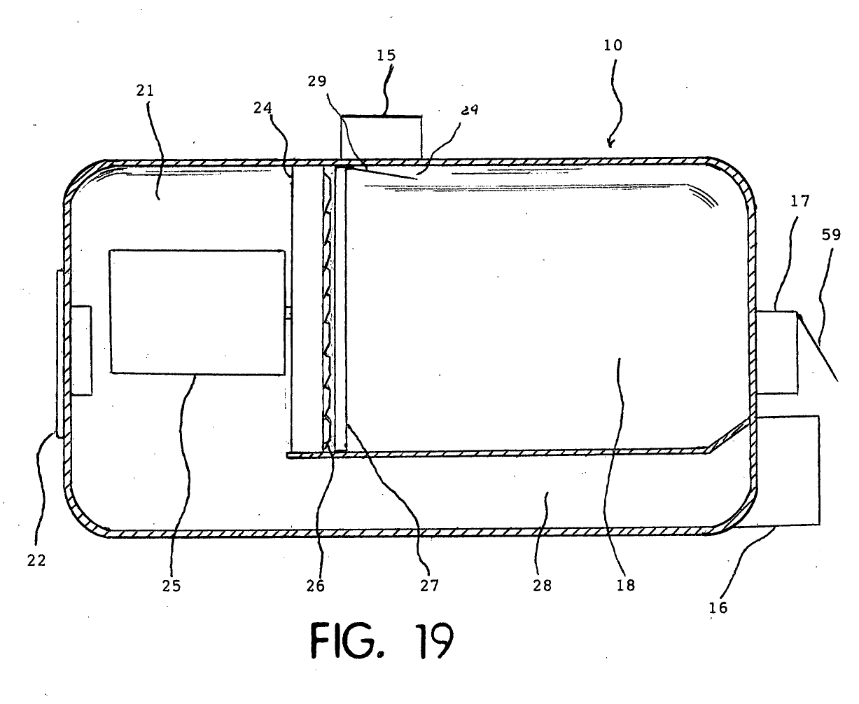

Referring now to FIG. 17, this is a side elevation of a typical central vacuum smoking assembly adapted for use in a vehicle such as an automobile and a closed place like a house, and it includes a waste collection chamber 18 and an air withdrawal chamber 21. It includes an air inlet port 15 with a door 29 in the inside place (shown in FIG. 19) it opens when the invention is used to smoke, and an outlet for filtered air to the atmosphere 16 (outside of the vehicle or a closed place) through a hose 56 (shown in FIG. 15), place the hose 56 properly in order to the smoke and air filtered goes outside from the vehicle o the closed place.

An debris exit 17 that has a door 59 it opens with the fan pressure when we connect the motor 25 with inverted polarity to remove the debris with air pressure through a hose 55 (shown in FIG. 15) properly place it outside the closed place where we do not want ashes and debris scattering.

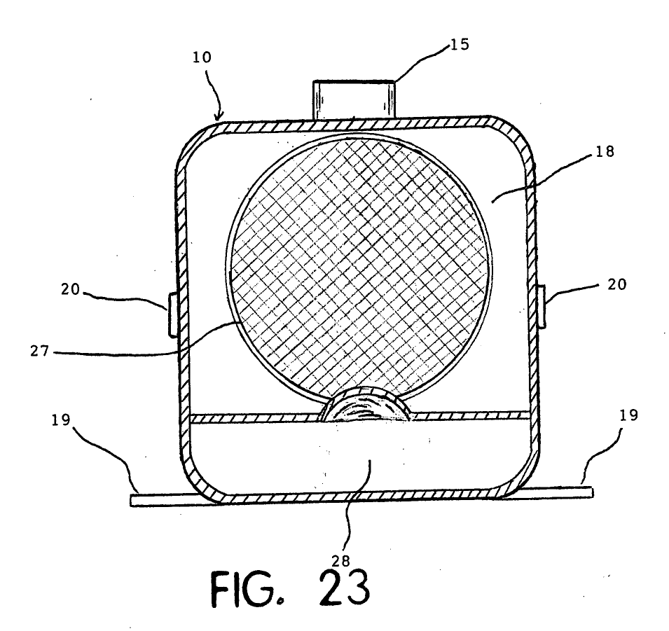

A conventional latch means 20 is used for convenient joining or detaching of the two main portions to form the assembly. This assembly is then easily adapted, by conventional easily detachable retaining means, such as clip or snap means, for installation in a vehicle or a closed place, and for quick detachment after removal from a vehicle, for emptying of particles, debris, and liquid wastes from the waste collection chamber 18, and for occasional cleaning of the air filter means 27 (shown in FIG. 23).

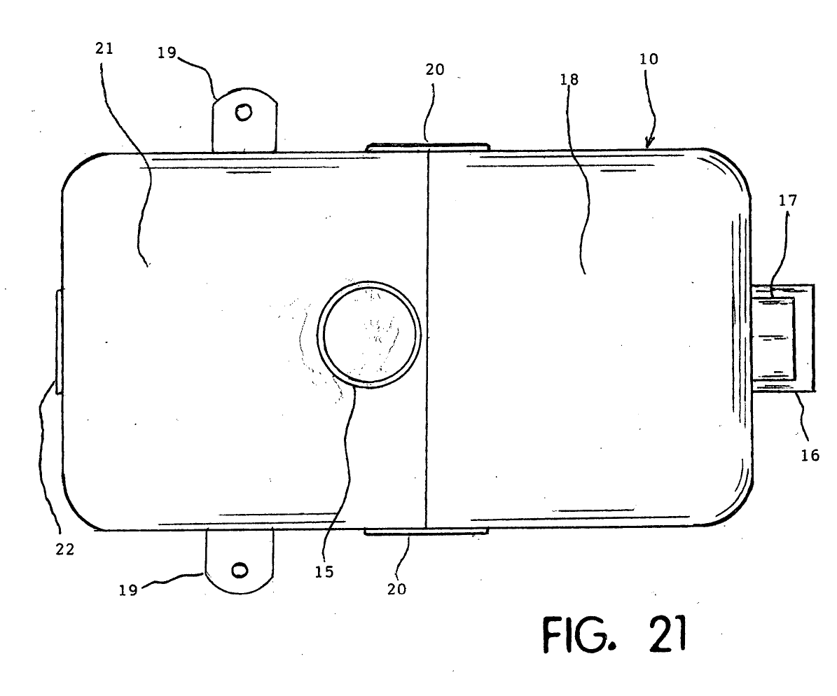

In FIG. 21 it also demonstrates two devices 19 to fix vacuum smoker 10 to a wall properly.

A main system switch 22 is installed on the top of the air withdrawal chamber at a convenient location, it can be remove properly to be installed on a wall of the vehicle.

A power supply port 23 is provided on the casing of the air withdrawal chamber, which of course contains the electric motor 25 (shown in FIG. 19).

A filter 27 shows in FIG. 23, as can be seen from these figures the motor fan 26 and filter assembly 27 are located in the upper portion of the chamber, the 28 air conduit and the opening 16 cooperate with filter 27 to provide an exit for filtered air to leave the waste collection chamber 18 and be drawn into the air withdrawal chamber 21.

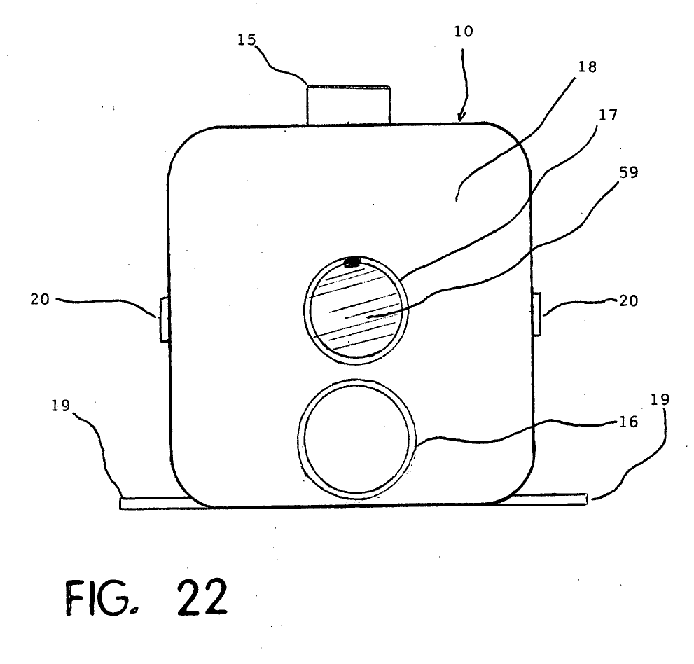

In the embodiment shown in FIGS. 17, 18, 21, and 22 the assembly has the overall appearance of a rectangular box with rounded corners, with a height of 4 inches, a horizontal width of 4 inches, and an overall length of 7½ inches. Of course these dimensions can be varied to suit the particular installation and performance parameters.

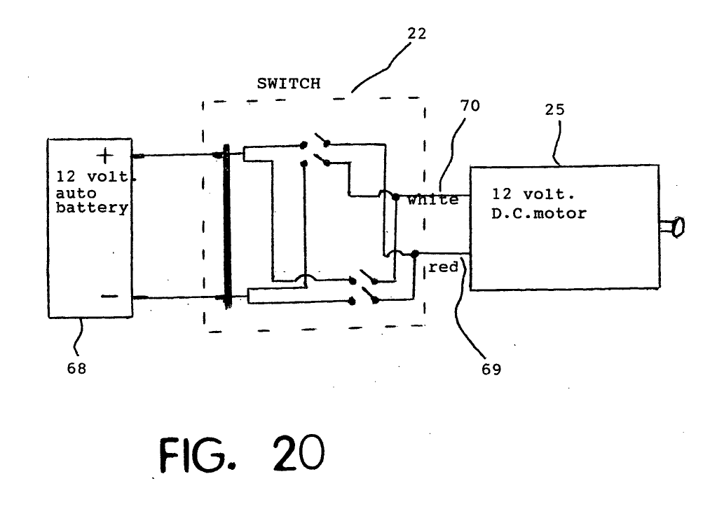

FIG. 20 shows semi-schematically the wiring diagram and certain elements used in the powering of the present invention, mainly switch 22 used to employed to run the present invention, properly changes the polarity, for turning on the dc motor 25 in the direction that we want.

When current is allowed to travel from power source to motor 25 via power switch 22, fan 26 is rotated; thereby, producing a vacuum within the hoses 44 and 51 and a positive pressure for directing smoke and debris into waste collection chamber 18. When current is allowed to travel from power source to motor 25 via power switch 22 it changes current polarity and fan 26 is rotated; thereby, producing a pressure that closes door 29 of the air intake 15 and opens door 59 of outlet port 17 to direct the debris outside of waste collection chamber 18 through a hose 55.

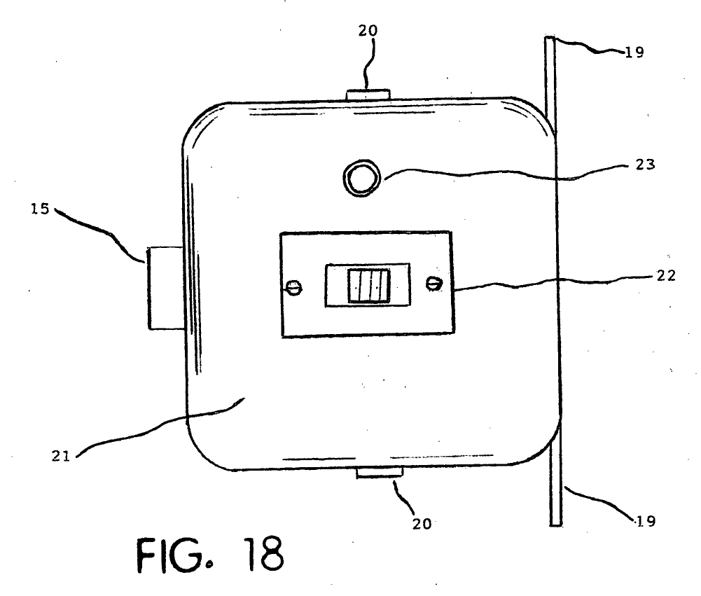

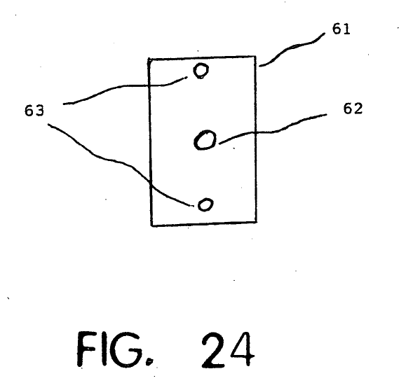

In FIG. 18 it shows a switch 22, it can be removed properly to be placed in a wall of the vehicle when the present invention is used in vehicle, and FIG. 24 shows the cover 61 that can be placed in the groove that leaves when removing switch 22. Cover 61 has a hole 62 to introduce the wires from the battery of a power supplies (not shown) and two holes 63 to assure with screws to vacuum 10.

While one embodiment of this invention has been described above, it will be evident to those skilled in the art that changes and modifications may be made therein without departing from the essence of this invention.

1. A personal air cleaning apparatus for preventing secondhand tobacco smoke, comprising:
a sucking/discharging unit having a suction inlet port for drawing in tabacco smoke, ashes and debris and a discharge port for discharging ashes and debris; an air withdrawal chamber and a waste collection chamber which are detachably held together in a suitable manner;
a flexible hose for sucking the tabacco smoke and ashes, with an end like a funnel, with various parts of a typical hose assembly;
a flexible hose for discharging filtered air;
a flexible hose for discharging debris'
a filter for outwardly discharging air received from the sucking/discharging unit while supplying clean air via the sucking/discharging unit;
at least one particulate filter for collecting smoke-borne particulate;

2. A personal air cleaning apparatus as claimed in claim 1 where whereing the flexible hose for sucking the tabacco smoke and ashes has a removable head like a funnel, mounted in a flexible conduit having two suction holes one to guide the flow of tabacco smoke and ashes and the second through the user blow by mouth or nose the inhaled smoke of the tabacco so does not scattering the smoke in the area.

3. A personal air cleaning apparatus as claimed in claim 1 where the suction inlet port for drawing in smoke and debris includes a flexible door that only opens when the personal cleaning apparatus is sucking through the suction inlet port.

4. A personal air cleaning apparatus as claimed in claim 1, whereing the flexible hose for discharging debris to guide the flow of discharged debris from the sucking/discharging unit can be placed in a convenient place like the flexible hose, for discharging filtered air.

5. A personal air cleaning apparatus as claimed in claim 1, whereing the waste collection chamber keeps debris and has a debris outlet with a door that opens with the fan pressure when it is connected the air cleaning apparatus with inverted polarity in order to remove debris and ashes with air pressure through this outlet that is conepted properly in order to the filtered smoke goes outside from the place that does not want the second hand smoke.

6. A personal air cleaning apparatus as claimed in claim 2, whereing the head like a funnel has a cigar/cigarette supporter and a cigar/cigarette compartment whit a hole to sucking the tabacco smoke.

7. A personal air cleaning apparatus as claim in claim 2, where the removable head like a funnel can be separated from the hose, to use the personal air cleaning apparatus like a vacuum cleaner in order to clean same places.

8. The personal air cleaning apparatus is adapted for use in a vehicle such as an automobile, a boat, an airplane, etc. and in a closed place like a house, an office, etc.

9. A personal air cleaning apparatus as claimed in claim 8, whereing the personal air cleaning apparatus is adapted to be placed in a vehicle or living or working place through hose coneptors.
